(19) United States
(12) Patent Application Publication
(10) Pub. No.: US 2026/0189974 A1
(43) Pub. Date: Jul. 2, 2026

(54) CONVERTING CELLULAR 5G DATA TRAFFIC FOR ETHERNET AND/OR WI-FI HARDWARE ACCELERATION

(71) Applicant: Fortinet, Inc., Sunnyvale, CA (US)

(72) Inventors: Kun Yu, San Jose, CA (US); Yan Li, Surrey (CA); Qiangmin Zhao, Palo Alto, CA (US)

(73) Assignee: Fortinet, Inc., Sunnyvale, CA (US)

(21) Appl. No.: 19/003,691

(22) Filed: Dec. 27, 2024

(51) Int. Cl. H04W 28/02

(52) U.S. Cl. CPC H04W 28/0273

(57) ABSTRACT

At a conversion sub-module of a 5G subsystem, the 5G data packets are converted from a 5G cellular data packet format to an Ethernet/Wi-Fi data packet format (and vice versa for upstream traffic). The converted data packets are transmitted from the 5G subsystem to a host system over a GMII channel, as a virtualized Ethernet interface, to an Ethernet packet hardware acceleration engine, to the Ethernet packet hardware acceleration engine. The 5G subsystem is connected to the host system as a USB device. The converted 5G cellular data packets are processed as Ethernet or Wi-Fi data packets through the Ethernet/Wi-Fit packet hardware acceleration engine. The Ethernet packet hardware acceleration engine bypasses a central processing unit. Then the converted data packet is transmitted downstream over Ethernet or Wi-Fi to a destination. Upstream traffic is received.

### FIELD OF THE INVENTION

The invention relates generally to computer networks, and more specifically, to converting cellular 5G data traffic for Ethernet and/or Wi-Fi hardware acceleration.

### BACKGROUND

Network hotspot devices enable local networking capabilities wherever a cell signal can be reached. The high-speed capability of 5G solutions easily substitute for wired solutions. These network devices constantly process exchanges between 5G transceivers and Ethernet transceivers.

Conventional network processing uses a central processing unit (CPU) to handle 5G data traffic. More specifically, a Universal Serial Bus (USB) connection or PCI-E bus transfers data packets to a host for handling by the CPU. Problematically, data packet processing can be intensive, especially during periods of high traffic, and consume CPU resources to the extent that other network functions of the network device are negatively affected. Moreover, CPUs are made for processing of all types and is not efficient for specialized, repetitive processing.

Therefore, what is needed is a robust technique for converting cellular 5G data traffic for Ethernet and/or Wi-Fi hardware acceleration.

### SUMMARY

To meet the above-described needs, methods, computer program products, and systems for converting cellular 5G data traffic for Ethernet and/or Wi-Fi hardware acceleration.

In one embodiment, at a 5G subsystem communicatively coupled to a cell tower, data packets of 5G cellular traffic are received traveling downstream from a cell tower. At a conversion sub-module of the 5G subsystem, the 5G data packets are converted from a 5G cellular data packet format to an Ethernet/Wi-Fi data packet format. Acceleration can be separate for Ethernet and Wi-Fi or there can be a common acceleration format. The converted data packets are transmitted from the 5G subsystem to a host system over a Gigabit Media Independent Interface (GMII) channel, as a virtualized Ethernet interface, to an Ethernet packet hardware acceleration engine, to the Ethernet packet hardware acceleration engine. The 5G subsystem is connected to the host system as a USB device.

In another embodiment, the converted 5G cellular data packets are processed as Ethernet or Wi-Fi data packets through the Ethernet/Wi-Fi packet hardware acceleration engine. The Ethernet packet hardware acceleration engine bypasses a central processing unit. Then the converted data packet is transmitted downstream over Ethernet or Wi-Fi to a destination. In some embodiments, the destination is display on a local data packet processing device.

In yet another embodiment, Ethernet or Wi-Fi data packets downstream are received at a host and processed through the Ethernet/Wi-Fi packet hardware acceleration engine. The Ethernet/Wi-Fi packet hardware acceleration engine bypasses a central processing unit. The processed data packets are transmitted to the 5G subsystem from the host system over the GMII channel, to a virtualized Ethernet interface. The conversion sub-module of the 5G subsystem converts the 5G data packets to a 5G cellular data packet format from an Ethernet or Wi-Fi data packet format. Finally, data packets of 5G cellular traffic traveling upstream are transmitted to the cell tower.

Advantageously, network performance and network device performance are improved with more efficient network data packet processing.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for converting downstream cellular 5G data traffic for Ethernet and/or Wi-Fi hardware acceleration, according to an embodiment.

FIG. 2 is a more detailed block diagram illustrating a data packet processing device of the system of FIG. 1, according to an embodiment.

FIG. 3 is a sequence diagram illustrating a data path for hardware acceleration from the components of the system of FIG. 1, according to an embodiment.

FIG. 4 is a high-level flow diagram of a method for converting downstream cellular 5G data traffic for Ethernet and/or Wi-Fi hardware acceleration, according to an embodiment.

FIG. 5 is a high-level flow diagram of a method for converting upstream cellular 5G data traffic for Ethernet and/or Wi-Fi hardware acceleration, according to an embodiment.

FIG. 6 is a block diagram illustrating an example computing device for the system of FIG. 1, according to an embodiment.

### DETAILED DESCRIPTION

Methods, computer program products, and systems for converting cellular 5G data traffic for Ethernet hardware acceleration. The following disclosure is limited only for the purpose of conciseness, as one of ordinary skill in the art will recognize additional embodiments given the ones described herein.

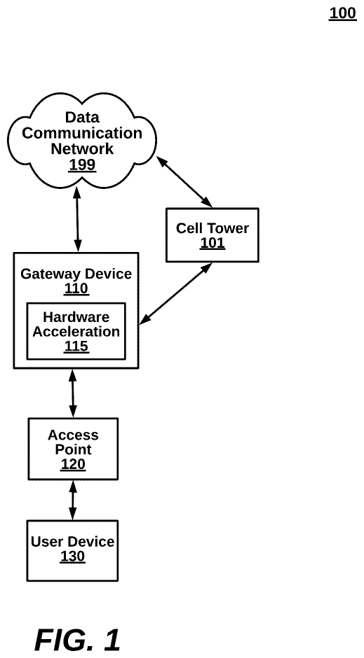

### I. Systems for 5G Packet Hardware Acceleration (FIGS. 1-3)

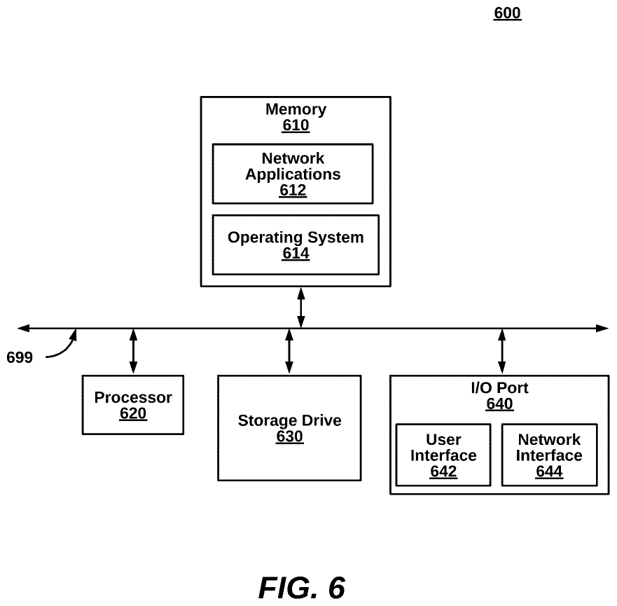

FIG. 1 is a high-level block diagram illustrating a system 100 for converting cellular 5G data traffic for Ethernet and/or Wi-Fi hardware acceleration, according to an embodiment. The system 100 includes a 5G network device 110, access point 120 and user device 130. Other embodiments of system 100 can include additional components that are not shown in FIG. 1, such as servers, gateways, Wi-Fi controllers, access points, routers and switches. There an also be additional 5G modems and other types of modems. The components of system 100 can be implemented in hardware, software, or a combination of both. An example implementation of processor-based hardware components is shown in FIG. 6.

In one embodiment, components of the system 100 are coupled in communication over a private (or enterprise) network connected to a public network, such as the Internet. In another embodiment, system 100 is an isolated, private network, or alternatively, a set of geographically dispersed LANs. The components can be connected to the data communication system via hard wire (e.g., network device 110). The components can also be connected via wireless networking (e.g., wireless stations and mesh networking nodes). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

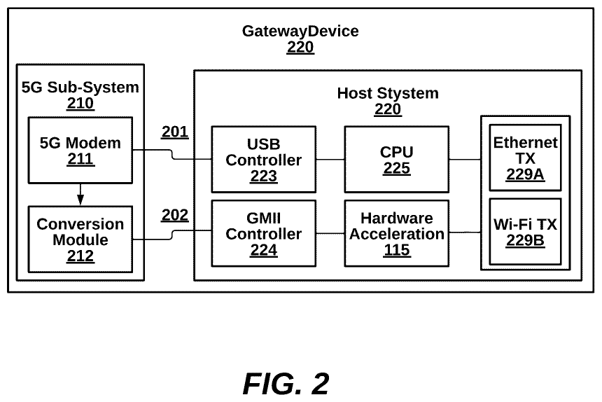

The 5G network device 110 processes, on an uplink side, incoming and outgoing traffic between LAN devices and 5G cell tower 101, using Ethernet and/or Wi-Fi acceleration hardware. Acceleration can be separate for Ethernet and Wi-Fi or there can be a common acceleration format. On a downlink side, the 5G modem provides a local LAN for Ethernet and Wi-Fi devices. In one case, the 5G network device 110 is a hotspot providing Internet service to a remote location that does not have underground wiring. In another case, a gateway device includes 5G and other uplink capabilities. In still another case, the 5G modem is integrated into a smartphone, laptop, tablet or video game console. Advantageously, CPU resources are conserved and specialized hardware can outperform generalized hardware. The 5G network device 110 is described in more detail below with respect to FIG. 2.

FIG. 2 is a more detailed view of the 5G network device 110 of FIG. 1, according to an embodiment. The 5G network device 110 further comprises a 5G subsystem 210 coupled to a host system 220 as a Universal Serial Bus (USB) device. A USB line 201 provides control data for AT and API communications. The 5G subsystem 112 is also communicatively coupled to the host system 114 with GMII line 202 for data layer communications. The GMII line 202 can act as a connection between the Media Access Control (MAC) layer and the Physical (PHY) layer in a network device, as defined by IEEE 802.3. One application is for Gigabit Ethernet applications, allowing data transfers at 1 Gbps.

In more detail, the 5G subsystem 112 end of the GMII line 202 virtualizes an Ethernet port such that the host system 114 exchanges data packets in the same manner as an Ethernet device. In some embodiments, the host system 114 is coupled with different subsystems, such as a 2.4G or a 6G subsystem.

The 5G subsystem 210 is communicatively coupled to receive data packets of 5G cellular traffic traveling downstream from a cell tower. A conversion module 212 changes data packets from a 5G cellular data packet format to an Ethernet data packet format. The 5G subsystem 210 forwards converted data packets to the host system 220 over the GMII line 202, as a virtualized Ethernet interface, converted data packets to the Ethernet packet hardware acceleration engine, to the Ethernet packet hardware acceleration engine. A USB controller 214 manages connection to the host system 220 as a USB device and also sends control signals corresponding to converted data packets (e.g., session data and security data). In some embodiments, the data packet routing can be dynamically switched to transmit 5G data packets over the USB line 201 for processing by a CPU of the host system 220.

The host system 220 further includes a CPU 225 and a hardware acceleration module 115. A host system end of the GMII line 202 receives converted Ethernet packets for accelerated processing. The Ethernet packet hardware acceleration engine 115 offloads the CPU 225 by routing 5G and Ethernet packets through the specialized hardware. The host system 220 then transmits the processed data packet downstream to a destination from Ethernet TX 229A or Wi-Fi TX 229B.

For upstream data packets sent from LAN devices, the Ethernet or Wi-Fi data packets are received at the host system 220 and sent through hardware acceleration. Then Ethernet data packets are transmitted over the GMII line 202 to the 5G subsystem 210 to a virtual Ethernet port where the Ethernet data packets are converted to 5G data packets for transmission to a cell tower.

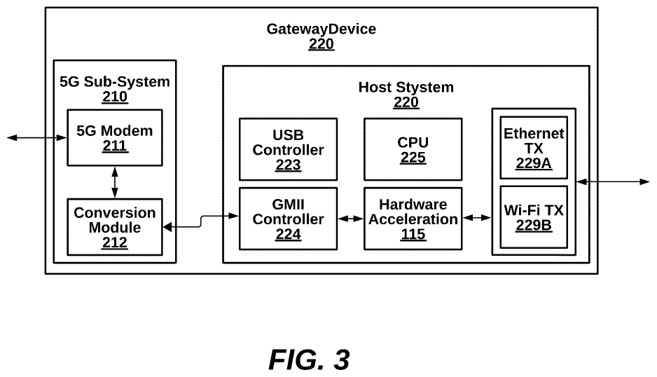

The data path for hardware acceleration is shown in FIG. 3. There are numerous variations to those that are listed herein, that would be apparent to one of ordinary skill in the art, given the disclosure herein.

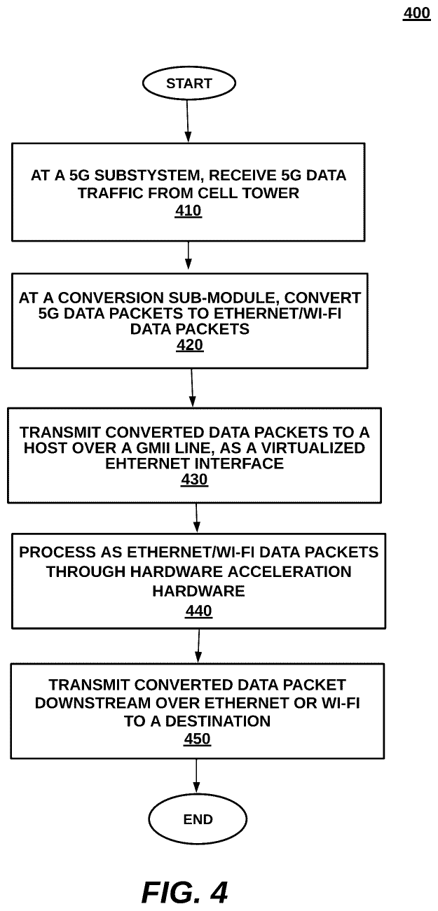

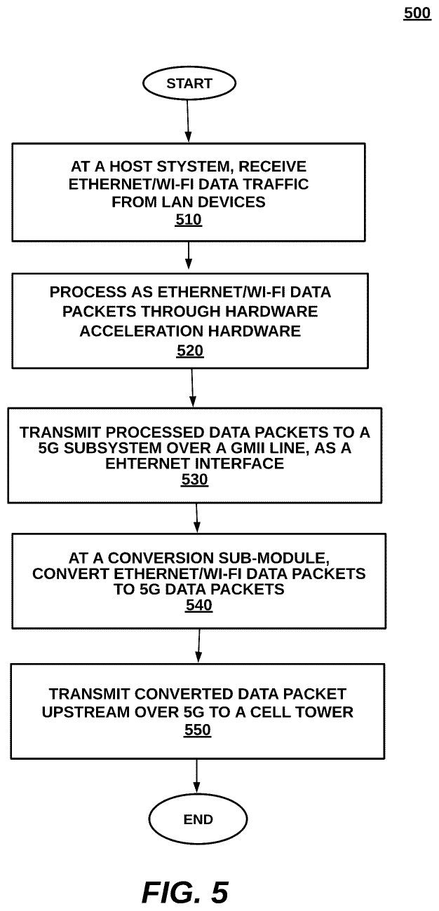

### II. Methods for 5G Packet Hardware Acceleration (FIGS. 4-5)

FIG. 4 is a high-level flow diagram of a method 400 for converting downstream cellular 5G data traffic for Ethernet and/or Wi-Fi hardware acceleration, according to an embodiment. The method 400 can be implemented by, for example, system 100 of FIG. 1. The specific grouping of functionalities and order of steps are a mere example as many other variations of method 500 are possible, within the spirit of the present disclosure. Other variations are possible for different implementations.

At step 410, at a 5G subsystem communicatively coupled to a cell tower, data packets of 5G cellular traffic are received traveling downstream from a cell tower.

At step 420, at a conversion sub-module of the 5G subsystem, the 5G data packets are converted from a 5G cellular data packet format to an Ethernet data packet format.

At step 430, the converted data packets are transmitted from the 5G subsystem to a host system over a GMII channel, as a virtualized Ethernet interface, to an Ethernet packet hardware acceleration engine, to the Ethernet packet hardware acceleration engine, wherein the 5G subsystem is connected to the host system as a USB device.

At step 440, the converted 5G cellular data packets are processed as Ethernet data packets through the Ethernet packet hardware acceleration engine. The Ethernet packet hardware acceleration engine bypasses a central processing unit.

At step 450, the converted data packet is transmitted downstream over Ethernet or Wi-Fi to a destination. In some embodiments, the destination is display on a local data packet processing device.

FIG. 5 is a high-level flow diagram of a method 500 for converting upstream cellular 5G data traffic for Ethernet hardware acceleration, according to an embodiment.

At step 510, Ethernet or Wi-Fi data packets received from downstream are received. At step 520, the Ethernet or W-Fi data packets are processed through the Ethernet/Wi-Fi packet hardware acceleration engine. The Ethernet/Wi-Fi packet hardware acceleration engine bypasses a central processing unit. At step 530, the processed data packets are transmitted to the 5G subsystem from the host system over the GMII channel, to a virtualized Ethernet interface. At step 540, at a conversion sub-module of the 5G subsystem, the 5G data packets are converted to a 5G cellular data packet format from an Ethernet or Wi-Fi data packet format. At step 550, data packets of 5G cellular traffic traveling upstream are transmitted to a cell tower.

### III. Computing Device for 5G Packet Hardware Acceleration (FIG. 6)

FIG. 6 is a block diagram illustrating a computing device 600, for use in system 100 of FIG. 1 in automatic virtual patching, according to one embodiment. The computing device 600 is a non-limiting example device for implementing each of the components of the system 100, including 5G network device 110, gateway 120, access point 130 and user device 140. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital /d/ or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

I claim:

1. A computer-implemented method in a data packet processing device, communicatively coupled to a data communication network, for converting cellular 5G data traffic for Ethernet hardware acceleration, the method comprising:
receiving, at a 5G subsystem communicatively coupled to a cell tower, data packets of 5G cellular traffic traveling downstream from a cell tower;
converting the 5G data packets, at a conversion sub-module of the 5G subsystem, from a 5G cellular data packet format to an Ethernet data packet format;
forwarding, from the 5G subsystem to a host system over a Gigabit Media Independent Interface (GMII) channel, as a virtualized Ethernet interface, converted data packets to the Ethernet packet hardware acceleration engine, to the Ethernet packet hardware acceleration engine, wherein the 5G subsystem is connected to the host system as a Universal Serial Bus (USB) device;
processing, at the host system, the converted 5G cellular data packets as Ethernet data packets through the Ethernet packet hardware acceleration engine, wherein the Ethernet packet hardware acceleration engine bypasses a central processing unit; and
transmitting the converted data packet downstream to a destination.

2. The method of claim 1, wherein the Ethernet data packets comprise Ethernet or Wi-Fi data packets.

3. The method of claim 2, further comprising:
forwarding control information associated with the converted data packets over a USB, from the 5G subsystem to the host system.

4. The method of claim 3, wherein the control information is processed by a central processing unit.

5. The method of claim 3, wherein the control information comprises AT commands and API calls.

6. The method of claim 1, wherein the host system comprises a USB port configured to receive 5G data packets.

7. The method of claim 1, wherein the step of transmitting the converted data packets downstream comprises transmitting the converted data packets downstream using Ethernet.

8. The method of claim 1, wherein the step of transmitting the converted data packets downstream comprises transmitting the converted data packets downstream using Wi-Fi.

9. A non-transitory computer-readable medium in a data packet processing device, on a data communication network, for converting cellular 5G data traffic for Ethernet hardware acceleration, the method comprising:
receiving, at a 5G subsystem communicatively coupled to a cell tower, data packets of 5G cellular traffic traveling downstream from a cell tower;
converting the 5G data packets, at a conversion sub-module of the 5G subsystem, from a 5G cellular data packet format to an Ethernet data packet format;
forwarding, from the 5G subsystem to a host system over a Gigabit Media Independent Interface (GMII) channel, as a virtualized Ethernet interface, converted data packets to the Ethernet packet hardware acceleration engine, to the Ethernet packet hardware acceleration engine, wherein the 5G subsystem is connected to the host system as a Universal Serial Bus (USB) device;
processing, at the host system, the converted 5G cellular data packets as Ethernet data packets through the Ethernet packet hardware acceleration engine, wherein the Ethernet packet hardware acceleration engine bypasses a central processing unit; and
transmitting the converted data packet downstream to a destination.

10. A data packet processing device for converting cellular 5G data traffic for Ethernet hardware acceleration, the data packet processing device comprising:
a 5G subsystem communicatively coupled to a cell tower, data packets of 5G cellular traffic traveling downstream from a cell tower;
a conversion sub-module of the 5G subsystem, to convert the 5G cellular traffic from a 5G cellular data packet format to an Ethernet data packet format;
a Gigabit Media Independent Interface (GMII) interface, to forward to a host system, as a virtualized Ethernet interface, wherein the 5G subsystem is connected to the host system as a Universal Serial Bus (USB) device;
an Ethernet packet hardware acceleration engine, at the host system, to process the converted 5G cellular data packets as Ethernet data packets, wherein the Ethernet packet hardware acceleration engine bypasses a central processing unit; and
a transceiver transmits the converted data packet downstream to a destination.
